(19) United States
(12) Patent Application Publication
(10) Pub. No.: US 2026/0161506 A1
(43) Pub. Date: Jun. 11, 2026

(54) STORAGE DEVICE DETERMINING DATA FAIL TYPES OCCURRING IN MEMORY DEVICE USING DISTRIBUTION SIMILARITY

(71) Applicant: Samsung Electronics Co., Ltd., Suwon-si (KR)

(72) Inventors: Minji Kang, Suwon-si (KR); JINHO SEO, Suwon-si (KR)

(21) Appl. No.: 19/378,393

(22) Filed: Nov. 4, 2025

(30) Foreign Application Priority Data
Dec. 11, 2024 (KR) 10-2024-0183601

(51) Int. Cl. G06F 11/10

(52) U.S. Cl. CPC G06F 11/1068; G06F 11/1016; G06F 11/1048

(57) ABSTRACT

A storage device includes a memory device storing a plurality of data, and a memory controller managing data fail of the memory device, wherein the memory controller classifies data fail of the memory device by the fail type and stores bad distribution data by the fail type, calculates similarity between the bad distribution data of the data fail that has occurred in the memory device and the stored bad distribution data, and determines the fail type of the data fail that has occurred in the memory device based on the similarity.

### CROSS-REFERENCE TO RELATED APPLICATION

This application claims priority under 35 U.S.C. § 119 to Korean Patent Application No. 10-2024-0183601 filed on Dec. 11, 2024, in the Korean Intellectual Property Office, the disclosure of which is incorporated by reference herein in its entirety.

### BACKGROUND

Example embodiments of the present disclosure described herein relate to a semiconductor memory device, and more particularly, relate to a storage device determining data fail types of a memory device using distribution similarity.

A semiconductor memory may be classified into a volatile memory or a non-volatile memory based on its data retention characteristics. The volatile memory, such as a dynamic random access memory (DRAM) or a static random access memory (SRAM), may lose data stored therein when power supply is turned off. In contrast, the non-volatile memory, such as a flash memory, a phase-change RAM (PRAM), a magneto-resistive RAM (MRAM), a resistive RAM (RRAM), or a ferroelectric RAM (FRAM), may retain data stored therein even when the power supply is turned off. Generally, write and read speed of the volatile memory are faster than those of the non-volatile memory.

Flash memory is one of the most widely used non-volatile memory devices as a storage device because of its high-density integration characteristics. Furthermore, flash memory may store multi-bit data in a memory cell. For example, flash memory may store two or more bits of data in one memory cell. Depending on the number of data bits stored in one memory cell, each memory cell of the flash memory may be in one of an erase state and a plurality of program states distinguished by their threshold voltage levels.

### SUMMARY

Example embodiments of the present disclosure provide a storage device that determines fail type of data fail that occurred in a memory device using the distribution similarity.

According to an embodiment, a storage device comprises a memory device configured to store a plurality of data, and a memory controller configured to classify data fails of the memory device by fail type, and to store the fail type and bad distribution data associated with data fails, wherein the memory controller is configured to calculate similarity between first bad distribution data of a first data fail that has occurred in the memory device and the stored bad distribution data, and determine the fail type of the first data fail based on the similarity.

According to an embodiment, a memory controller that manages data fail of a memory device, comprises a bad distribution data table configured to store bad distribution data categorized by fail type of a data fail of the memory device, and a fail log collection module configured to calculate similarity between first bad distribution data of a first data fail that has occurred in the memory device and the bad distribution data stored in the bad distribution data table, and store the bad distribution data and fail location data categorized by the fail type according to the similarity.

According to an embodiment, an operating method of a memory controller which manages data fail of a memory device, the method comprises calculating similarity between first bad distribution data of a first data fail of the memory device and bad distribution data stored in a bad distribution data table, and storing the bad distribution data and fail location data categorized by fail type in a fail log collection module according to the similarity.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating an example embodiment of a storage device according to the present disclosure.

FIG. 2 is a block diagram illustrating an example embodiment of the memory device illustrated in FIG. 1.

FIG. 3 is a circuit diagram illustrating an example embodiment of a memory block BLK1 of the memory cell array illustrated in FIG. 2.

FIG. 4 is a circuit diagram illustrating cell strings selected by the first string selection line SSL1 from the memory block BLK1 illustrated in FIG. 3.

FIG. 5 is a diagram illustrating an example threshold voltage distributions of memory cells illustrated in FIG. 4.

FIG. 6 is a block diagram illustrating an example embodiment of the memory controller in FIG. 1.

FIG. 7 is a block diagram illustrating an example embodiment of an operation method of the fail log managing unit illustrated in FIG. 6.

FIGS. 8 and 9 are graphs illustrating example of data fail that has occurred in the memory device.

FIG. 10 is a block diagram illustrating an example embodiment of the fail log managing unit illustrated in FIG. 1.

FIG. 11 is a block diagram illustrating an example embodiment of an operation method of the fail log managing unit illustrated in FIG. 10.

FIG. 12 is a flowchart illustrating an example embodiment of the operation method of the fail log managing unit illustrated in FIG. 10.

FIG. 13 illustrates an example embodiment of a method for calculating the similarity of the bad distribution data performed in operation S130 of FIG. 12.

FIG. 14 is a block diagram illustrating an embodiment of the fail log managing unit illustrated in FIG. 1.

FIG. 15 is a flowchart illustrating an example embodiment of the operation method of the bad block managing module illustrated in FIG. 14.

FIG. 16 is a block diagram illustrating an example embodiment of the fail log managing unit illustrated in FIG. 1.

FIG. 17 and FIG. 18 are block diagrams and graphs illustrating an example embodiment of the operation method of the bad distribution update module illustrated in FIG. 16.

FIG. 19 is a flowchart illustrating an example embodiment of the operation method of the bad distribution update module shown in FIG. 16.

FIG. 20 is a diagram illustrating an example embodiment of a memory device having a multi-stack structure.

FIG. 21 is a block diagram illustrating a solid state drive (SSD) to which a storage device according to an embodiment of the present disclosure is applied.

### DETAILED DESCRIPTION

Below, example embodiments of the present disclosure will be described in detail and clearly to such an extent that an ordinary one in the art can easily implement the inventive concepts.

As is traditional in the field of the disclosed technology, features and embodiments are described, and illustrated in the drawings, in terms of functional blocks, units, and/or modules. In the case of the blocks, units, and/or modules being implemented by microprocessors or similar, they may be programmed using software (e.g., microcode) to perform various functions discussed herein and may optionally be driven by firmware and/or software.

Items described in the singular herein may be provided in plural, as can be seen, for example, in the drawings. Thus, the description of a single item that is provided in plural should be understood to be applicable to the remaining plurality of items unless context indicates otherwise.

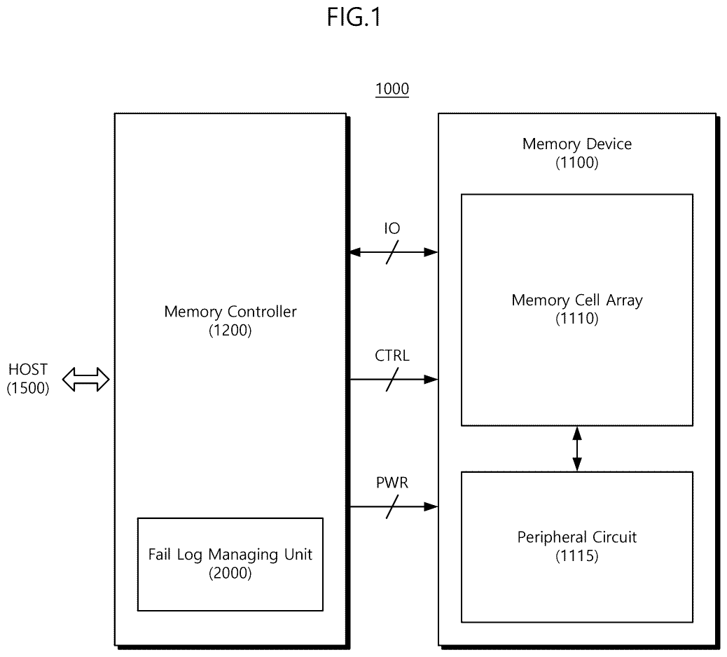

FIG. 1 is a block diagram illustrating an example embodiment of a storage device according to the present disclosure.

Referring to FIG. 1, the storage device 1000 may include a memory device 1100 and a memory controller 1200. The storage device 1000 may be a flash storage device based on a flash memory. For example, the storage device 1000 may be implemented as a solid-state drive (SSD), a universal flash storage (UFS), a memory card, or the like.

The storage device 1000 may communicate with the host 1500 through a host interface. The storage device 1000 may receive a write request to store data in the memory device 1100 or a read request to read data stored in the memory device 1100 from the host 1500. The requests from the host 1500 may include data which may be identified by a logical address.

The memory device 1100 may receive input/output signals IO from the memory controller 1200 through input/output lines, receive control signals CTRL through control lines, and receive external power supply PWR through power lines. The storage device 1000 may store data in the memory device 1100 under the control of the memory controller 1200.

The memory device 1100 may include a memory cell array 1110 and a peripheral circuit 1115. The memory cell array 1110 may have a vertical 3D structure. The memory cell array 1110 may include a plurality of memory cells. Multi-bit data may be stored in each memory cell.

The memory cell array 1110 may be located (e.g., disposed) next to or above the peripheral circuit 1115. A memory device structure in which the memory cell array 1110 is positioned over the peripheral circuit 1115 may be a cell-on-periphery (COP) structure.

The memory cell array 1110 may be manufactured as a separate chip distinguished from a chip including the peripheral circuit 1115, and may be assembled in a single package together with the chip including the peripheral circuit 1115. The chip including the memory cell array 1110 may be an upper chip and the chip including the peripheral circuit 1115 may be a lower chip, in which the upper chip is disposed on the lower chip. The upper chip including the memory cell array 1110 and a lower chip including the peripheral circuit 1115 may be bonded together, and may be electrically connected to each other through bonding pads disposed on each surface of the upper chip and the lower chip. This type of a memory structure may be referred to as a chip-to-chip (C2C) structure.

The peripheral circuit 1115 may include analog circuits and/or digital circuits used to store data in the memory cell array 1110 or read data stored in the memory cell array 1110. The peripheral circuit 1115 may receive the external power PWR through power lines and generate internal powers of various levels.

The peripheral circuit 1115 may receive commands, addresses, and/or data from the memory controller 1200 through input/output lines. The peripheral circuit 1115 may write the data in the memory cell array 1110 according to the control signals CTRL. Additionally, the peripheral circuit 1115 may read data stored in the memory cell array 1110 and provide the read data to the memory controller 1200.

The memory controller 1200 may include a fail log managing unit 2000 to manage data fail of the memory device 1100. When data fail occurs in the memory device 1100, the fail log managing unit 2000 may analyze a threshold voltage distribution of memory cells in the memory device 1100, classify data fail of the memory device 1100 by fail type based on the threshold voltage distribution, and store the threshold voltage distribution corresponding to the fail type as bad distribution data. For classifying the data fail, the fail log managing unit 2000 may calculate similarity between the threshold voltage distribution of the data fail that has occurred in the memory device 1100 and the bad distribution data stored in the fail log managing unit 2000, and may determine the fail type of the data fail that has occurred in the memory device 1100 based on the similarity. The fail log managing unit 2000 may be a functional module formed as software that configures a processor of the memory controller 1200.

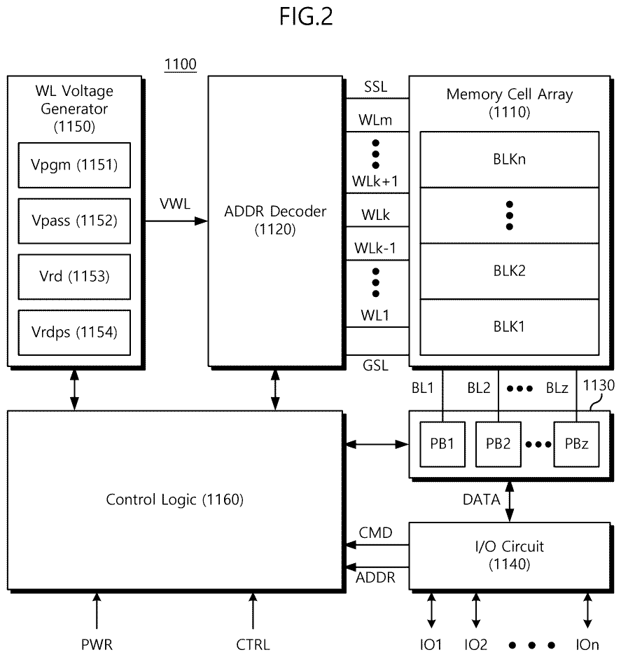

FIG. 2 is a lower connection layer 121 diagram illustrating an example embodiment of the memory device illustrated in FIG. 1.

Referring to FIG. 2, the memory device 1100 may include the memory cell array 1110 and the peripheral circuit 1115 shown in FIG. 1. The peripheral circuit 1115 may include an address decoder 1120, a page buffer circuit 1130, a data input/output circuit 1140, a word line voltage generator 1150, and a control logic 1160.

The memory cell array 1110 may include a plurality of memory blocks BLK1 to BLKn. Each memory block may include a plurality of pages. Each page may include a plurality of memory cells. Each memory cell may store multi-bit data (e.g., two or more bits). Each memory block may correspond to an erase unit, and each page may correspond to a read unit and/or a write unit. Each memory block may include a plurality of physical pages of memory. A physical page of memory may comprise a plurality of memory cells (e.g., memory cell transistors) that are connected together and share a word line. A memory block may have all of its physical pages of memory erased together (e.g., simultaneously) in the same erase operation. A memory block may constitute the minimal unit of erase in the memory device (i.e., it may not be possible to erase physical pages or other portions of a memory block without erasing the entire memory block).

The memory cell array 1110 may include memory cells stacked vertically in a direction perpendicular to a substrate. The memory cells may be implemented by depositing a gate electrode layer and an insulation layer alternately on the substrate. Each memory block (e.g., BLK1) may be connected to one or more string selection lines SSL, a plurality of word lines WL1 to WLm, and one or more ground selection lines GSL. WLk is a selected word line sWL and the remaining word lines (WL1 to WLk−1, WLk+1 to WLm) are unselected word lines uWL.

The address decoder 1120 may be connected to the memory cell array 1110 through string selection lines SSL, ground selection lines GSL and word lines WL1 to WLm. The address decoder 1120 may select a word line during a program or read operation. The address decoder 1120 may receive a word line voltage VWL including a program voltage and a read voltage from the word line voltage generator 1150 and provide the program voltage or the read voltage to the selected word line.

The page buffer circuit 1130 may be connected to the memory cell array 1110 through bit lines BL1 to BLz. The page buffer circuit 1130 may temporarily store data to be stored in the memory cell array 1110 or data read from the memory cell array 1110. The page buffer circuit 1130 may include page buffers PB1 to PBz, each connected to its respective bit line. Each page buffer may include a plurality of latches to store multi-bit data to be programmed into the memory cell array 1110 or to store multi-bit data read from the memory cell array 1110.

The input/output circuit 1140 may be internally connected to the page buffer circuit 1130 through data lines and externally connected to the memory controller 1200 (refer to FIG. 1) through the input/output lines IO1 to IOn. The input/output circuit 1140 may receive program data from the memory controller 1200 during a program operation. Additionally, the input/output circuit 1140 may provide data read from the memory cell array 1110 to the memory controller 1200 during a read operation. The memory controller may be a processor (i.e., a hardware circuit), such as a microprocessor, a CPU (Central Processing Unit), a GPU (graphics processor), a digital signal processor (DSP), a field-programmable gate array (FPGA), etc., and may be part of a computer. Such a controller may be formed by several interconnected controllers and may be configured by software.

The word line voltage generator 1150 may receive internal power from the control logic 1160 and generate word line voltages VWL used to perform a read or program operation. The word line voltages VWL may be provided to a selected word line sWL or unselected word lines uWL through the address decoder 1120.

The word line voltage generator 1150 may include a program voltage generator 1151 and a pass voltage generator 1152. The program voltage generator 1151 may generate a program voltage Vpgm, and provide the program voltage Vpgm to the selected word line sWL during a program operation. The pass voltage generator 1152 may generate a pass voltage Vpass, and provide the pass voltage Vpass to the unselected word lines uWL.

The word line voltage generator 1150 may include a read voltage generator 1153 and a read pass voltage generator 1154. The read voltage generator 1153 may generate a select read voltage Vrd, and provide the select read voltage Vrd to the selected word line sWL during a read operation. The read pass voltage generator 1154 may generate a read pass voltage Vrdps, and provide the read pass voltage Vrdps to unselected word lines uWL. The read pass voltage Vrdps may be a voltage sufficient to turn on memory cells connected to the unselected word lines uWL during a read operation.

The control logic 1160 may control the memory device 1100 to perform a write operation, read operation, and erase operation by providing commands CMD, addresses ADDR, and control signals CTRL to the memory device 1100. The addresses ADDR may include a block selection address for selecting a memory block, a row address for selecting a page, and a column address for selecting a specific memory cell from the memory cells within the selected page for read or write operation.

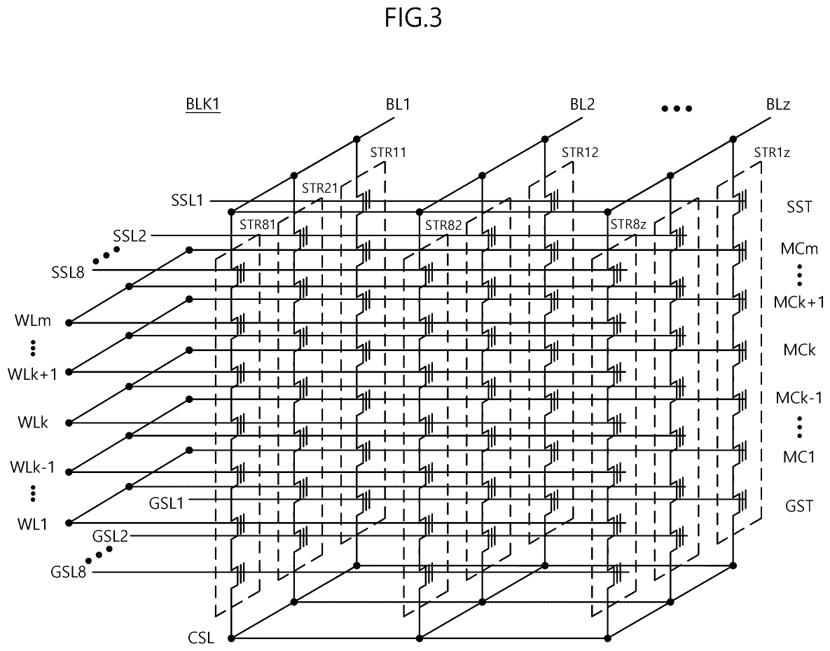

FIG. 3 is a circuit diagram illustrating an example embodiment of a memory block BLK1 of the memory cell array illustrated in FIG. 2.

Referring to FIG. 3, in the memory block BLK1, a plurality of cell strings STR11 to STR8z may be formed between the bit lines BL1 to BLz and a common source line CSL. Each cell string includes a string selection transistor SST, a plurality of memory cells MC1 to MCm, and a ground selection transistor GST.

The string selection transistors SST may be connected with string selection lines SSL1 to SSL8. The ground selection transistors GST may be connected with ground selection lines GSL1 to GSL8. The string selection transistors SST may be connected with the bit lines BL1 to BLZ, and the ground selection transistors GST may be connected with the common source line CSL.

The first to m-th word lines WL1 to WLm may be connected with the plurality of memory cells MC1 to MCm in a row direction. The first to z-th bit lines BL1 to BLz may be connected with the plurality of memory cells MC1 to MCm in a column direction. First to z-th page buffers PB1 to PBz may be connected with the first to z-th bit lines BL1 to BLz.

The first word line WL1 may be placed above the first to eighth ground selection lines GSL1 to GSL8. The first memory cells MC1 may be connected with the first word line WL1 at the same height from the substrate. The m-th word line WLm may be located below the first to eighth string selection lines SSL1 to SSL8. The m-th memory cells MCm may be connected with the m-th word line WLm at the same height from the substrate. Likewise, each of the second to (m−1)-th memory cells MC2 to MCm−1 may be connected with the corresponding second to (m−1)-th word lines WL2 to WLm−1 at the same heights from the substrate.

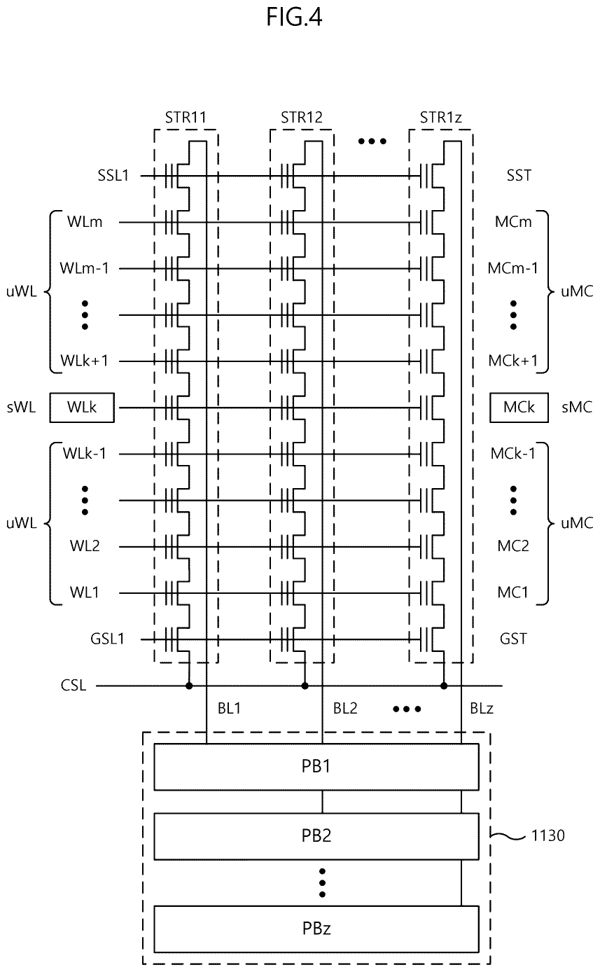

FIG. 4 is a circuit diagram illustrating cell strings selected by the first string selection line SSL1 from among the cell strings of the memory block BLK1 illustrated in FIG. 3.

The cell strings STR11 to STRIz may be selected by the first string selection line SSL1. The cell strings STR11 to STRIz may be connected to the first to z-th bit lines BL1 to BLZ, respectively. The first to z-th page buffers PB1 to PBz may be connected to the first to z-th bit lines BL1 to BLz, respectively.

The cell string STR 11 may be connected to the first bit line BL1 and the common source line CSL. The cell string STR11 may include string selection transistors SST selected by the first string selection line SSL1, first to m-th memory cells MC1 to MCm connected to the first to m-th word lines WL1 to WLm, and ground selection transistors GST selected by the first ground selection line GSL1. The cell string STR12 may be connected to the second bit line BL2 and the common source line CSL. The cell string STRIz may be connected to the z-th bit line BLz and the common source line CSL.

The first word line WL1 and the m-th word line WLm may be edge word lines (edge WL). The second word line WL2 and the (m−1)-th word line WLm−1 may be edge adjacent word lines. The k-th word line WLk may be a selected word line sWL. The (k−1)-th word line WLk−1 and the (k+1)-th word line WLk+1 may be adjacent word lines adjacent to the selected word line. If the k-th word line WLk is the selected word line sWL, the remaining word lines WL1 to WLk−1 and WLk+1 to WLm may be unselected word lines uWL.

The first memory cells MC1 and the m-th memory cells MCm may be edge memory cells. The second memory cells MC2 and the (m−1)-th memory cells MCm−1 may be edge adjacent memory cells. The k-th memory cells MCK may be selected memory cells sMC. The (k−1)-th memory cells MCk−1 and the (k+1)-th memory cells MCk+1 may be memory cells adjacent to the selected memory cells (i.e., adjacent MC). If the k-th memory cells MCK are selected memory cells sMC, the remaining memory cells MC1 to MCk−1 and MCk+1 to MCm may be unselected memory cells uMC.

A set of memory cells selected by one string selection line and connected to one word line may constitute a page. For example, memory cells selected by the first string selection line SSL1 and the k-th word line WLk may be constitute the first page among the pages associated with the k-th word line WLk. For example, eight pages may be configured on the k-th word line WLk. Among the eight pages, the first page connected to the first string selection line SSL1 may be selected by selecting the first string selection line SSL1, and the remaining pages connected to the second to eighth string selection lines SSL2 to SSL8 may be unselected pages.

The first word line WL1 is a first edge word line (i.e., Edge1 WL), and the second word line WL2 is a first edge adjacent word line (i.e., Edge1 adjacent WL). The m-th word line WLm is the second edge word line (i.e., Edge2 WL), and the (m−1)-th word line WLm−1 is the second edge adjacent word line (i.e., Edge2 adjacent WL). The word lines between the first and second edge adjacent word lines are middle word lines. For example, the k-th word line WLk, where k is natural number greater than or equal to three and less than or equal to m−2, between the second word line WL2 and the (m−1)-th word line WLm−1 is a middle word line.

During the read operation, if the second word line WL2 is the selected word line sWL, the remaining word lines may be unselected word lines uWL. The second word line WL2 may be a first edge adjacent word line (i.e., Edge1 adjacent WL). The second memory cells MC2 connected with the second word line WL2 may be selected memory cells sMC. The remaining memory cells may be unselected memory cells uMC.

If the (m−1)-th word line WLm−1 is the selected word line sWL, the remaining word lines may be unselected word lines uWL. The (m−1)-th word line WLm−1 may be a second edge adjacent word line. The (m−1)-th memory cells MCm−1 connected with the (m−1)-th word line WLm−1 may be selected memory cells sMC. The remaining memory cells may be unselected memory cells uMC.

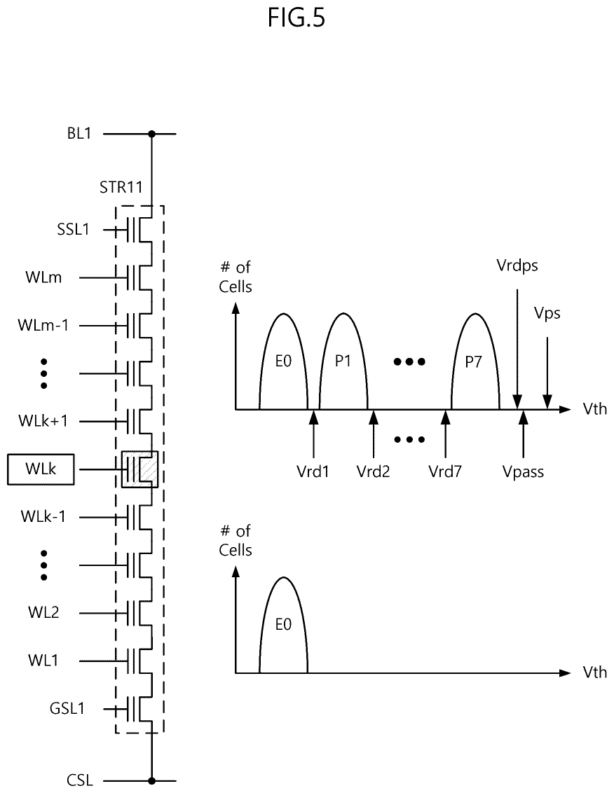

FIG. 5 is a diagram illustrating an example threshold voltage distributions of memory cells illustrated in FIG. 4.

The horizontal coordinate denotes a threshold voltage Vth of memory cells, and the vertical coordinate denotes the number of memory cells. Each memory cell may be configured to store three-bit data. The memory cell configured to store three-bit data may be in one of eight states (E0, P1 to P7) according to the threshold voltage of the memory cell. E0 represents an erase state, and P1 to P7 represent program states.

During a read operation, the selection read voltages Vrd1 to Vrd7 may be provided to the selected word line sWL, and the pass voltage Vps and/or the read pass voltage Vrdps may be provided to the unselected word lines uWL. The pass voltage Vps and/or the read pass voltage Vrdps may be a voltage sufficient to turn on the memory cells connected with the unselected word lines uWL. For example, the pass voltage Vps may be provided to the adjacent word lines WLk±1, and the read pass voltage Vrdps may be provided to the unselected word lines other than the adjacent word lines.

The first selection read voltage Vrd1 may be a voltage level between the erase state E0 and the first program state P1. The second selection read voltage Vrd2 may be a voltage level between the first and second program states P1 and P2. Likewise, the seventh selection read voltage Vrd7 may be a voltage level between the sixth and seventh program states P6 and P7.

When the first selection read voltage Vrd1 is applied to a memory cell for read operation, the memory cell in the erase state E0 may be an on-cell and the memory cell in the first to seventh program states P1 to P7 may be an off-cell. The on-cell may indicate a memory cell that is turned on and the off-cell may indicate a memory cell that is turned off. When the second selection read voltage Vrd2 is applied, the memory cell in the erase state E0 and the first program state P1 may be an on-cell, and the memory cell in the second to seventh program states P2 to P7 may be an off-cell. Likewise, when the seventh selection read voltage Vrd7 is applied, the memory cell in the erase state E0 and the first to sixth program states P1 to P6 may be an on-cell and the memory cell in the seventh program state P7 may be an off-cell.

During a read operation, the k-th word line WLk may be selected. A string selection voltage and ground selection voltage may be applied to the string selection line SSL1 and the ground selection line GSL1 respectively, and the string select transistor SST and the ground select transistor GST may be turned on. The string selection voltage and ground selection voltage may correspond to a power voltage. Thereafter, the selection read voltage Vrd may be provided to the selected word line sWL, and the read pass voltage Vrdps and/or the pass voltage Vps may be provided to the unselected word lines uWL.

When the read operation is repeatedly performed on the k-th word line WLk, the high voltage pass voltage Vps and the read pass voltage Vrdps may be repeatedly provided to the unselected word lines. Due to the repeated read operation on the k-th word line WLk, the unselected word lines may be affected by read disturbance, and the threshold voltages of the memory cells connected to the unselected word lines may be shifted from the programmed threshold voltages. Memory cells connected to the k-th word line WLk may be off-cells when a selection read voltage Vrd is provided. More specifically, when the threshold voltage of the k-th memory cell is higher than the selection read voltage Vrd, the k-th memory cell may be an off-cell. When the k-th memory cell is an off-cell, a channel for current flowing may be disconnected at the k-th memory cell and current may not flow through the k-th memory cell. Therefore, a lower channel of the k-th memory cell may be affected by a ground voltage from the common source line CSL, and an upper channel of the k-th memory cell may be affected by a bit line voltage, and may have a negative channel voltage.

Because the channel is disconnected at the k-th memory cell, a channel voltage difference may occur between a lower channel of the first to (k−1)-th memory cell and an upper channel of the (k+1)-th to m-th memory cell. Due to the channel voltage difference, hot carrier injection (HCl) may occur in adjacent memory cells MCk+1 and/or MCk−1 and, threshold voltages of memory cells connected to adjacent word lines WLk+1 and/or WLk−1 may be shifted. For example, the threshold voltages of memory cells in the erase state E0 may be shifted to the first program state (P1).

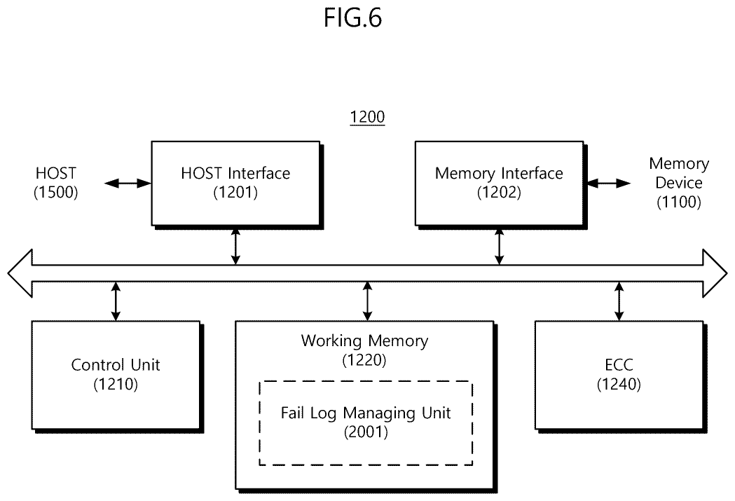

FIG. 6 is a block diagram illustrating an example embodiment of the memory controller in FIG. 1. Referring to FIG. 6, the memory controller 1200 may include a host interface 1201, a memory interface 1202, a control unit 1210, a working memory 1220, and an ECC circuit 1240. The working memory 1220 may store fail log data of a fail log managing unit 2001. The fail log data may include fail type, and bad distribution data corresponding to the fail type. The working memory may be responsible for temporarily holding and processing information in the memory controller 1200. It plays a role in reasoning, learning, and decision-making. Unlike long-term memory, which stores information indefinitely, the working memory is limited in capacity and duration.

The memory controller 1200 may further include various components. For example, the memory controller 1200 may include a buffer memory that temporarily stores data generated from a read or write operation of the memory device 1100. The memory controller 1200 may further include a buffer control module for controlling the buffer memory, or a command generation module for generating a command for controlling a memory operation according to a request from the host 1500, etc.

The host interface 1201 may provide an interface between the host 1500 and the memory controller 1200. Standard interfaces may include advanced technology attachment (ATA), serial ATA (SATA), external SATA (e-SATA), small computer small interface (SCSI), serial attached SCSI (SAS), peripheral component interconnection (PCI), PCI express (PCI-E), IEEE 1394, universal serial bus (USB), secure digital card (SD), multi-media card (MMC), embedded multi-media card (eMMC), universal flash storage (UFS), compact flash (CF), etc.

The memory interface 1202 may provide an interface between the memory device 1100 and the memory controller 1200. For example, write or read data may be transmitted to and received from the memory device 1100 through the memory interface 1202. The memory interface 1202 may provide commands and/or addresses to the memory device 1100. The memory interface 1202 may provide data read from the memory device 1100 to the memory controller 1200.

The control unit 1210 may include a central processing unit or microprocessor, and may control the overall operation of the memory controller 1200. The control unit 1210 may drive firmware loaded in the working memory 1220 to control the memory controller 1200.

The working memory 1220 may be implemented with various types of memory, such as DRAM, SRAM, or PRAM. The working memory 1220 may store fail log data of the fail log managing unit 2001 under the control of the control unit 1210. The memory controller 1200 may load the fail log data stored in the memory device 1100 into the fail log managing unit 2001 of the working memory 1220 during power-up sequence.

The ECC circuit 1240 may generate an error correction code (ECC) to correct fail bits or error bits of data received from the memory device 1100. The ECC circuit 1240 may perform error correction encoding on data to generate a parity bit with respect to the data, and provide the memory device 1100 with the data and the parity bit. The parity bit may be stored in the memory device 1100.

The ECC circuit 1240 may perform error correction decoding on data received from the memory device 1100. The ECC circuit 1240 may correct errors using the parity bit. The ECC circuit 1240 may correct errors using coded modulation, such as low density parity check (LDPC) code, Bose-Chaudhuri-Hocquenghem code (BCH code), turbo code, Reed-Solomon code, convolution code, recursive systematic code (RSC), trellis-coded modulation (TCM), and block coded modulation (BCM).

The ECC circuit 1240 may correct errors within its capability to correct errors. For example, the ECC circuit 1240 may correct errors of up to 40 bits for 2K bytes of page data, in which the maximum number of errors allowed in 2K bytes of page data is 40 bits. Accordingly, the ECC circuit 1240 may not correct errors in the page if the number of errors included in the page is more than 40 bits. A page including errors that may not be corrected by the ECC circuit 1240 is treated as a bad page. A memory cell in a bad page that includes an error is called a bad cell.

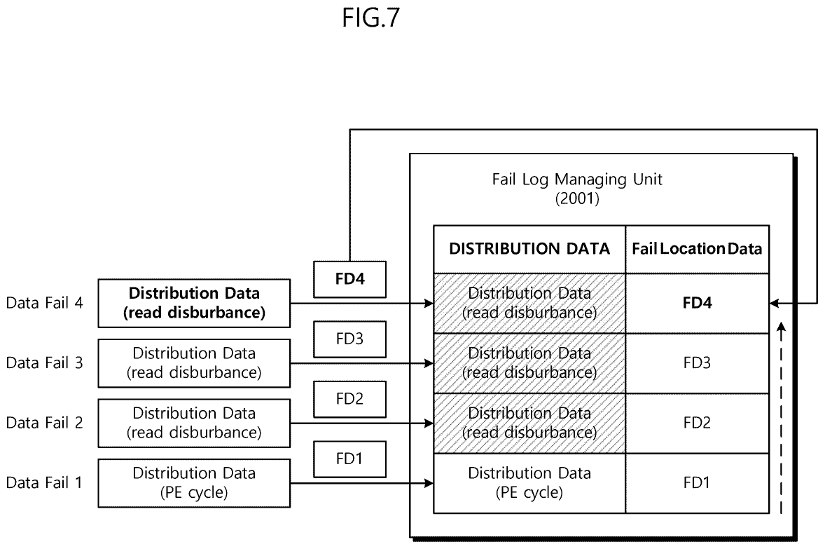

FIG. 7 is a block diagram illustrating an example embodiment of an operation method of the fail log managing unit illustrated in FIG. 6. Referring to FIG. 7, the fail log managing unit 2001 may store distribution data and fail location data. The distribution data (e.g., bad distribution data) may be bad distribution information of memory cells with defects. For example, bad distribution data may be information including the threshold distributions all of the of cells in a page, which page includes a data fail (e.g., an uncorrectable error). Therefore, a specific example of bad distribution data is the memory cell voltage threshold distribution for of a failed page. Bad distribution data may be failed page distribution data (e.g., failed page voltage threshold distribution data). Various types of data fail may occur in the memory device 1100. The fail location data may identify location of the data fail in the memory device 1100. The fail log managing unit 2001 may manage distribution data and fail location data of memory cells with respect to data fails that have occurred in the memory device 1100.

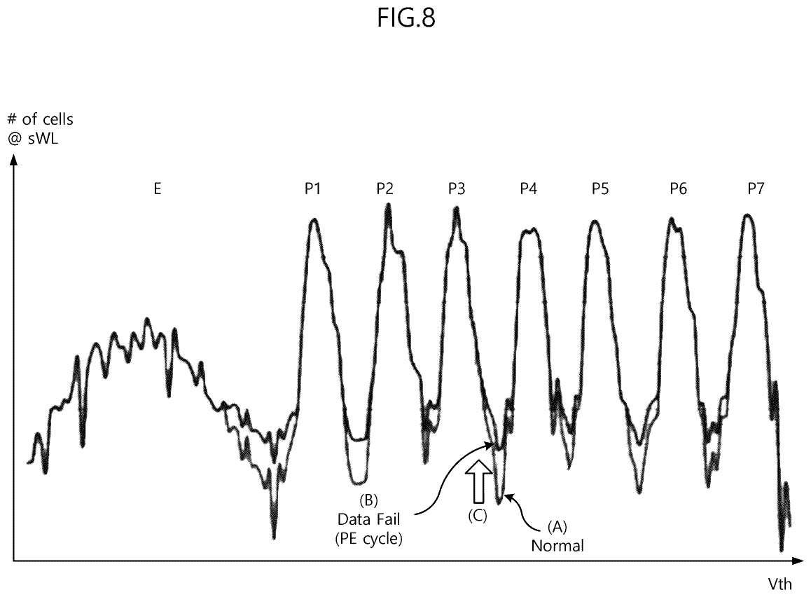

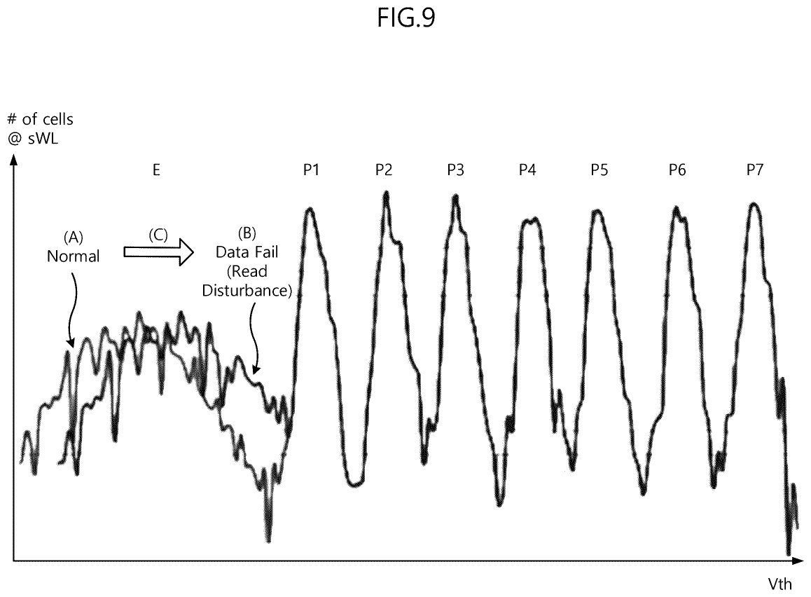

FIGS. 8 and 9 are graphs illustrating examples of data fail that has occurred in the memory device. In FIGS. 8 and 9, a horizontal coordinate denotes a threshold voltage Vth of memory cells, and a vertical coordinate denotes the number of a selection memory cells (e.g., # of cells @ sWL) connected to a selected word line sWL. FIG. 8 illustrates distribution data of data fail caused by a program-erase cycle (PE cycle), and FIG. 9 illustrates distribution data of data fail caused by a read disturbance.

Referring to FIGS. 7 and 8, the first data fail may occur due to program-erase cycles (PE cycles). If the program-erase cycles are repeated in the memory device 1100, the oxide of the memory cell may deteriorate. Many traps may occur due to the deterioration of the oxide. Due to the electrons trapped in the traps, the valley of the normal distribution state (A) may be changed toward another distribution state in a direction of (C), and may reach the data distribution state (B) which is regarded as a data fail state. The distribution data and the first fail location data FD1 may be stored in the fail log managing unit 2001.

Referring to FIGS. 7 and 9, after the distribution data and the first fail location data FD1 related to the first data fail is stored in the fail log managing unit 2001, the second to fourth data fails may occur sequentially in the memory device 1100. All of the second to fourth data fails may be caused by the read disturbance. The data fail due to read disturbance may occur when a read operation of a selected word line is repeatedly performed. A read pass voltage (see FIG. 5, Vrdps) may be repeatedly provided to the unselected word lines and causes threshold voltage of the memory cells connected to the unselected word lines to shift. Due to the read disturbance, the normal erase distribution state (A) may be soft-programmed. The normal erase distribution state (A) may move toward another distribution state in a direction of (C), and may reach the data distribution state (B) which is regarded as a data fail state.

When the second to fourth data fails occur, the distribution data and the second to fourth fail-location data (FD2 to FD4) may be stored in the fail log managing unit 2001. Because the second to fourth data fails are all caused by read disturbance, the distribution data corresponding to the second to fourth data fails may be similar. Although the distribution data are similar, the fail log managing unit 2001 may store bad distribution data corresponding to the second to fourth data fails in different memory space respectively. For example, the distribution data due to the second to fourth data fails may have similar distribution data corresponding to the data distribution state (B) of FIG. 9. The hatched distribution data in FIG. 7 may be similar to each other.

The fail log managing unit 2001 illustrated in FIG. 7 may have a limited memory space to store fail log data. The fail log managing unit 2001 may store distribution data and fail-location data in a round-robin manner in the memory space to store fail log data related to the recently occurred data fails first. The fail log managing unit 2001 may need a large memory space because the same types of data fails may occur repeatedly and the size of the distribution data corresponding to the data fails may be large.

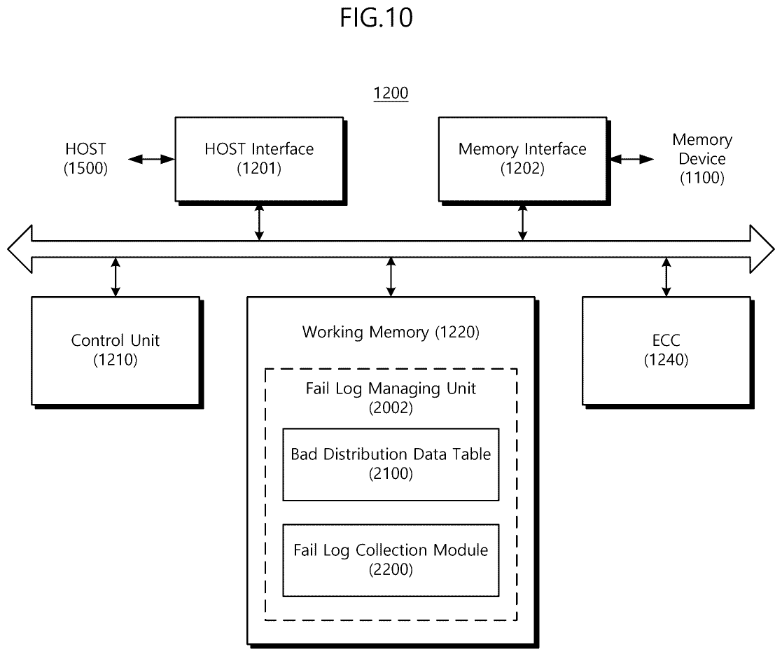

FIG. 10 is a block diagram illustrating an example embodiment of the fail log managing unit illustrated in FIG. 1. Referring to FIG. 10, the memory controller 1200 may include a host interface 1201, a memory interface 1202, a control unit 1210, a working memory 1220, and an ECC circuit 1240.

The working memory 1220 may store fail log data of a fail log managing unit 2002. The memory controller 1200 may load the fail log data stored in the memory device 1100 into the fail log managing unit 2002 during a power up sequence. The fail log managing unit 2002 may include a bad distribution data table 2100 and a fail log collection module 2200.

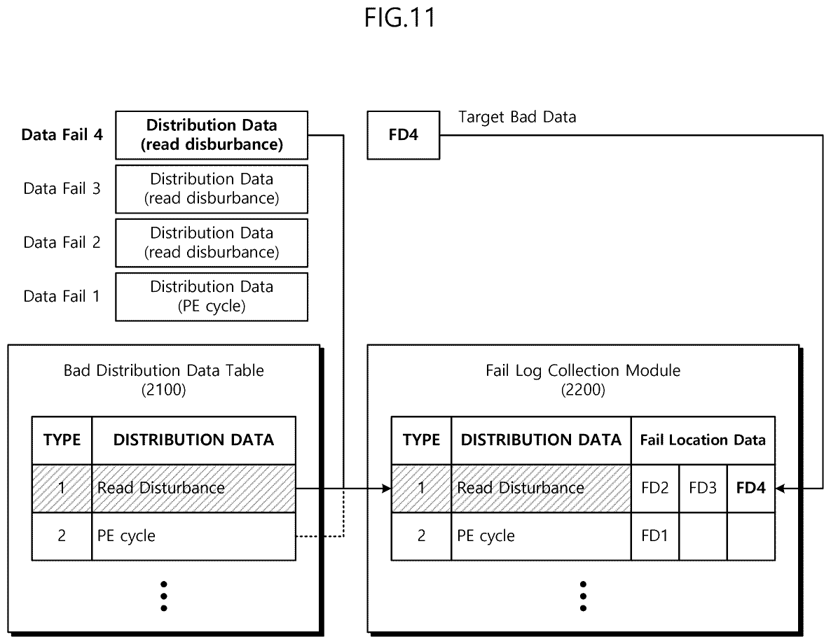

FIG. 11 is a block diagram illustrating an example embodiment of an operation method of the fail log managing unit illustrated in FIG. 10. Referring to FIG. 11, first to fourth data fails may occur sequentially in the memory device 1100. The first data fail may occur due to a program-erase cycle, and the second to fourth data fails may occur due to a read disturbance.

The fail log managing unit 2002 may classify fail types of data fails of the memory device 1100. The fail log managing unit 2002 may store distribution data and fail-location data classified as the same fail type in a field of the fail log managing unit 2002. The fail log managing unit 2002 may calculate the similarity between the distribution data of the data fail that has currently occurred in the memory device 1100 and the distribution data stored in the bad distribution data table 2100. Hereinafter, the distribution data stored in the bad distribution data table 2100 may be called bad distribution data.

The fail log managing unit 2002 may determine the fail type of the data fail has currently occurred in the memory device 1100 based on the similarity. Bad distribution data determined to be a different fail type from the fail types of the DB distribution data may be stored in a different row of the bad distribution data table 2100. For example, the first bad distribution data due to the read disturbance (see FIG. 9) and second bad distribution data due to a program-erase cycle (see FIG. 8) may be stored in different rows of the bad distribution data table 2100.

The fail log collection module 2200 may store fail types of distribution data and bad data corresponding to the fail types. For example, when the first data fail occurs at a location of the first fail location data FD1 due to the program-erase cycles, the fail log collection module 2200 may store the first fail-location data FD1 as the second fail type. The second fail type may be identified as data fail due to the program-erase cycle from the bad distribution data table 2100.

When the second data fail occurs, the fail log collection module 2200 may store the second fail-location data FD2 as the first fail type due to the read disturbance. When the third data fail occurs, the fail log collection module 2200 may store the third fail-location data FD3 as the first fail type. When the fourth data fail occurs, the fail log collection module 2200 may store the fourth fail-location data FD4 as the first fail type. The fail log collection module 2200 may store second to fourth fail-location data FD2 to FD4 as the first fail type in the same row. The first fail type may be identified as data fail due to the read disturbance from the bad distribution data table 2100.

The fail log managing unit 2002 may search the bad distribution data with the highest similarity to the distribution data of the data fail that has currently occurred. The fail location data which indicates location of the data fail that currently has occurred may be a target fail location data. Based on the search result, the fail log managing unit 2002 may determine the fail type and store the target fail location data in the fail log collection module 2200. The fail log managing unit 2002 may store the bad distribution data and the fail location data in the same row of the fail log collection module 2200 storing fail location data of the same fail type. The fail log managing unit 2002 may prevent bad distribution data of the same fail types (e.g., bad distribution data due to read disturbance) from being stored repeatedly and redundantly. Accordingly, the fail log managing unit 2002 may use data storage space efficiently by reducing wasted space. The fail log managing unit 2002 may include a plurality of rows to store the bad distribution data and the fail location data. Each row of the plurality of rows may store one bad distribution data in associated with a specific fail type and one or more fail location data of the specific fail type.

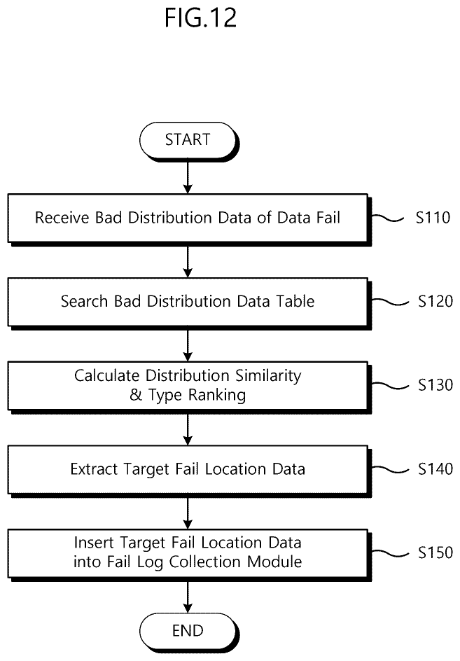

FIG. 12 is a flowchart illustrating an example embodiment of the operation method of the fail log managing unit illustrated in FIG. 10. Referring to FIGS. 11 and 12, the fail log managing unit 2002 may store the bad distribution data and the fail location data efficiently by storing the fail location data of same fail type in the same row of the fail log collection module 2200.

In operation S110, the fail log managing unit 2002 may receive a bad distribution data of data fail from the memory device 1100. For example, a fourth data fail may occur in the memory device 1100 due to the read disturbance. The fail log managing unit 2002 may receive the bad distribution data due to the read disturbance from the memory device 1100.

In operation S120, the fail log managing unit 2002 may search the bad distribution data table 2100. The fail log managing unit 2002 may search the fail types of the bad distribution data stored in the bad distribution data table 2100. The fail log managing unit 2002 may find out through the search that the first fail type of the bad distribution data is due to the read disturbance, and the second fail type of the bad distribution data is due to the program-erase cycle.

In operation S130, the fail log managing unit 2002 may calculate distribution similarity between the received bad distribution data from the memory device 1100 and the bad distribution data stored in the bad distribution data table 2100, and determine type ranking which indicates a degree of similarity with each fail type. The fail log managing unit 2002 may calculate the distribution similarity between the data fail that has occurred in the memory device 1100 and the bad distribution data stored in the bad distribution data table 2100. The fail log managing unit 2002 may determine the fail type of the data fail that has occurred in the memory device 1100 based on the distribution similarity.

For example, the bad distribution data of the data fail may be similar to the distribution data as shown in (B) of FIG. 9. The fail log managing unit 2002 may calculate the similarity of the distribution data received from the memory device 1100 with each distribution data of the bad distribution data table 2100. The fail log managing unit 2002 may calculate the similarity of the distribution data and determine the type ranking for each of the fail types.

In operation S140, the fail log managing unit 2002 may extract target fail location data. The fail log managing unit 2002 may collect data regarding the location of the failed data after determining the fail type. Here, the collected data is called target fail location data.

In operation S150, the fail log managing unit 2002 may insert the target fail location data into the fail log collection module 2200. The fail log managing unit 2002 may store the target fail location data in the fail log collection module 2200 by adding it in a row storing other fail location data of the same fail type. Since the second to fourth data fails are caused by read disturbance, the target fail location data FD4 may be stored in the row of the fail log collection module 2200 in which the second and third fail location data FD2 and FD3 are stored. Since the fail log collection module 2200 stores the target fail location data by fail type, the fail log collection module 2200 may avoid storing similar bad distribution data repeatedly. For example, the hatched portion in FIG. 7 may not be stored in the fail log collection module 2200.

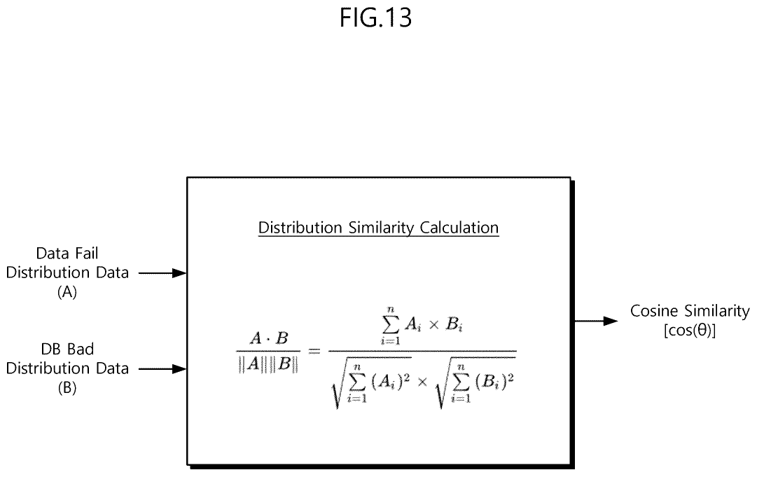

FIG. 13 illustrates an example embodiment of a method for calculating the similarity of the bad distribution data performed in operation S130 of FIG. 12. The fail log managing unit 2002 may receive the distribution data (A) of the data fail in the memory device 1100 and may search the distribution data (B) stored in the bad distribution data table 2100, and calculate the distribution similarity between the distribution data (A) and the distribution data (B).

The distribution similarity may be measured by several different methods. For example, it may be calculated using cosine similarity by measuring the similarity between two vectors. The closer the measuring value of cosine similarity is to 1, the higher the similarity may be.

When a data fail occurs in the memory device 1100, the fail log managing unit 2002 may obtain distribution data, and convert it into a first vector as shown in FIG. 13. The fail log managing unit 2002 may convert the distribution data stored in the bad distribution data table 2100 into a second vector. The fail log managing unit 2002 may calculate the similarity between the first and second vectors using a mathematical formula shown in FIG. 13. As a result of calculating the distribution similarity, the fail log managing unit 2002 may determine the fail type of the data fail that occurred in the memory device 1100 as one of the fail types which are closest in similarity.

The fail log data stored in the fail log managing unit 2002 may be used for debugging while performing a failure analysis of the memory device 1100. However, the fail log managing unit 2002 may have limited memory space for storing the fail log data. The fail log managing unit 2002 illustrated in FIG. 11 may determine the fail type of data fail that has occurred in the memory device 1100 according to the distribution data similarity. Because the bad distribution data and target fail location data may be stored along with other fail location data of the same fail type in a row of the fail log managing unit 2002, the fail log managing unit 2002 may store more debugging information efficiently in the same memory space.

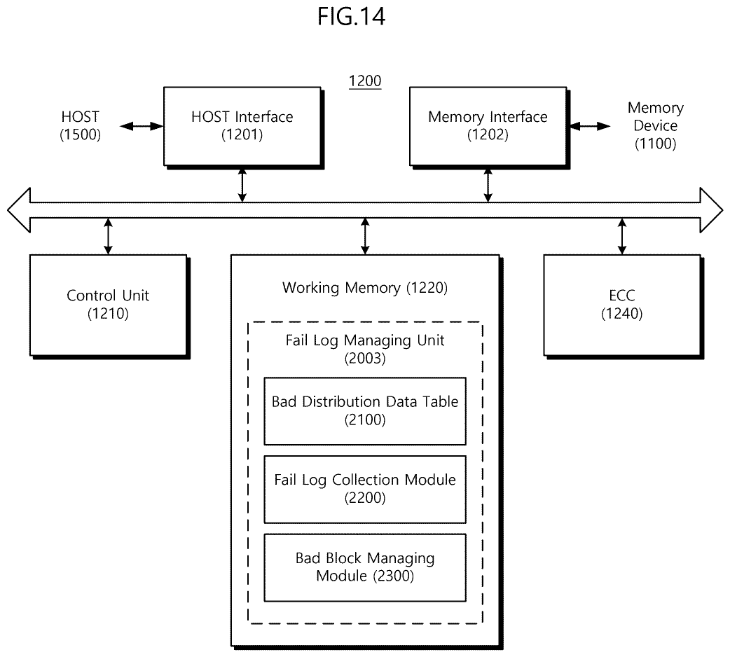

FIG. 14 is a block diagram illustrating an example embodiment of the fail log managing unit illustrated in FIG. 1. Referring to FIG. 14, the memory controller 1200 may include a host interface 1201, a memory interface 1202, a control unit 1210, a working memory 1220, and an ECC circuit 1240.

The working memory 1220 may store fail log data of a fail log managing unit 2003. The working memory 1220 may load the fail log data stored in the memory device 1100 into the fail log managing unit 2003, when the memory device 1100 is powered up.

The fail log managing unit 2003 may include a bad distribution data table 2100, a fail log collection module 2200, and a bad block managing module 2300. The bad distribution data table 2100 and the fail log collection module 2200 may function as described above. Therefore, following description will be focused on the bad block managing module 2300.

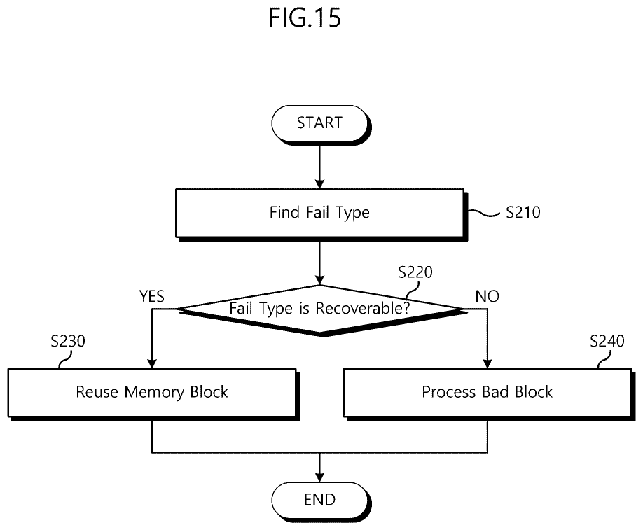

FIG. 15 is a flowchart illustrating an example embodiment of the operation method of the bad block managing module illustrated in FIG. 14. Referring to FIGS. 14 and 15, the bad block managing module 2300 may determine a fail type using the distribution data similarity described above (S210) and determine whether the fail type is recoverable (S220).

If fail type is recoverable (YES), the bad block managing module 2300 may reuse a memory block including the fail location data through a recovery operation (S230). Here, the recovery operation of the memory block may be performed within the memory device 1100. The memory device 1100 may perform a recovery operation such as a reclaim operation under the control of the bad block managing module 2300.

If fail type is not recoverable (NO), the bad block managing module 2300 may process the corresponding memory block as a bad block and no longer use it (S240). As the memory cells of the memory device 1100 are stacked in a vertical direction (e.g., vertical NAND referred to as VNAND), the size of one memory block increases and the total number of memory blocks decreases. Since the size of one memory block increases and the total number of memory blocks decreases, if one memory block is processed as a bad block, the wasted portion of the memory device 1100 due to the bad block may also increase.

The fail log managing unit 2003 illustrated in FIG. 14 may identify the fail type in real time (run-time) when a data fail occurs in the memory device 1100. The bad block managing module 2300 may determine the possibility of recovering the memory block based on the fail type. As the fail log managing unit 2003 stores more debugging information, the bad block managing module 2300 may increase the reusability of the memory block.

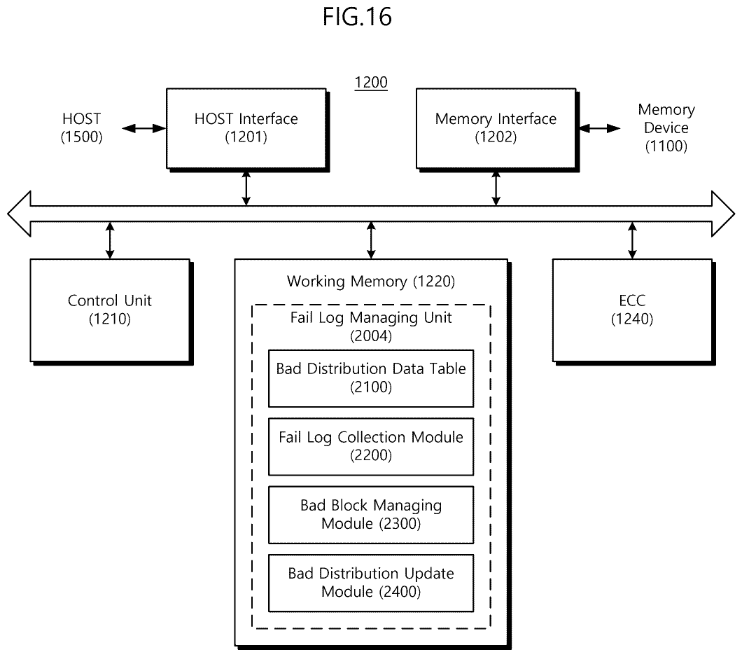

FIG. 16 is a block diagram illustrating another example embodiment of the fail log managing unit illustrated in FIG. 1. Referring to FIG. 16, the memory controller 1200 may include a host interface 1201, a memory interface 1202, a control unit 1210, a working memory 1220, and an ECC circuit 1240.

The working memory 1220 may store fail log data of a fail log managing unit 2004. The working memory 1220 may load the fail log data stored in the memory device 1100 into the fail log managing unit 2004, when the memory device 1100 is powered up.

The fail log managing unit 2004 may include a bad distribution data table 2100, a fail log collection module 2200, a bad block managing module 2300, and a bad distribution update module 2400. The bad distribution data table 2100, the fail log collection module 2200, and the bad block managing module 2300 may function as described above. Therefore, following description will be focused on the bad distribution update module 2400.

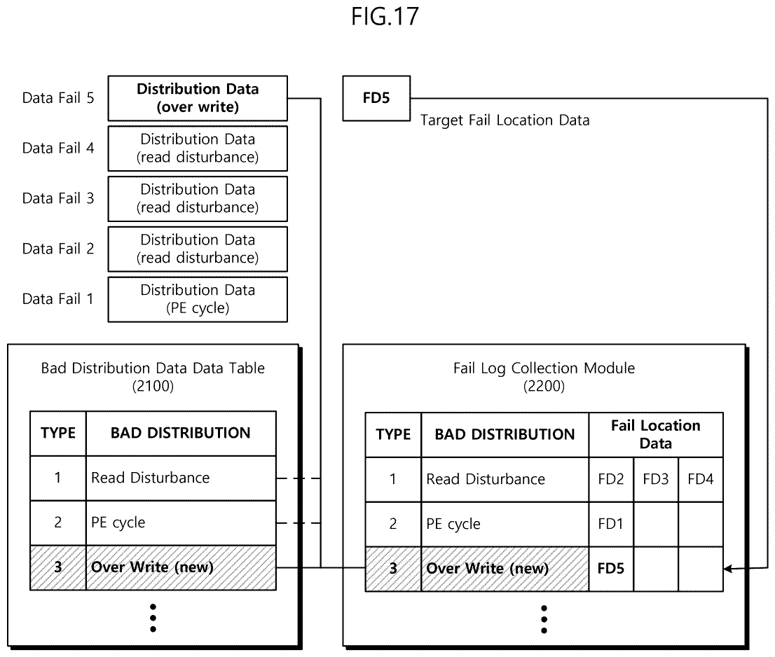

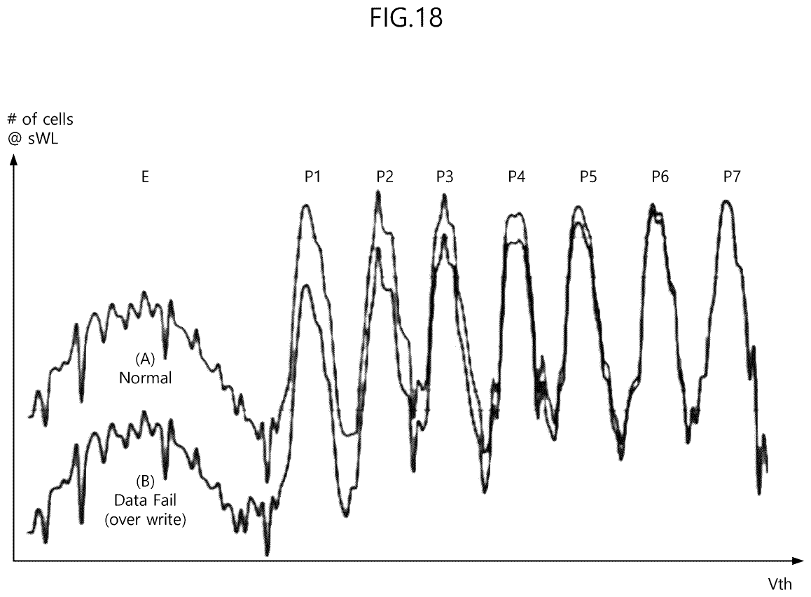

FIG. 17 and FIG. 18 are block diagrams and graphs illustrating an example embodiment of the operation method of the bad distribution update module illustrated in FIG. 16. Referring to FIG. 17, a fifth data fail may occur newly in the memory device 1100. The fifth data fail may occur due to, for example, overwrite. The bad distribution update module 2400 may update the bad distribution data table 2100 to include information with respect to distribution data and fail location data of the fifth data fail newly occurred in the memory device 1100.

Referring to FIGS. 17 and 18, the fail type of the fifth data fail may be overwrite. The data fail due to overwrite may occur when a page already programmed in the memory device 1100 is reprogrammed without an erase operation. Overwrite may occur when address mapping information is incorrect in the flash translation layer (FTL). The FTL may be a hardware circuit or a functional module formed as software that configures the processor 113 or another processor of the storage controller 110. The FTL may also include one or more data tables (e.g., an address translation table) that may be part of buffer memory 114 or a separate memory.

When data fail occurs due to overwrite, the number of erase cells may be reduced. As the number of erased cells decreases, the program state progresses from the first program state (P1) to the seventh program state (P7), and the peak of the distribution may increase. Through data randomization, the memory device 1100 may typically ensures that the number of memory cells for each state remains nearly uniform. However, if overwriting is performed in the memory device 1100, the distribution data may be changed in which the number of memory cells in higher program states increases, as illustrated in FIG. 18.

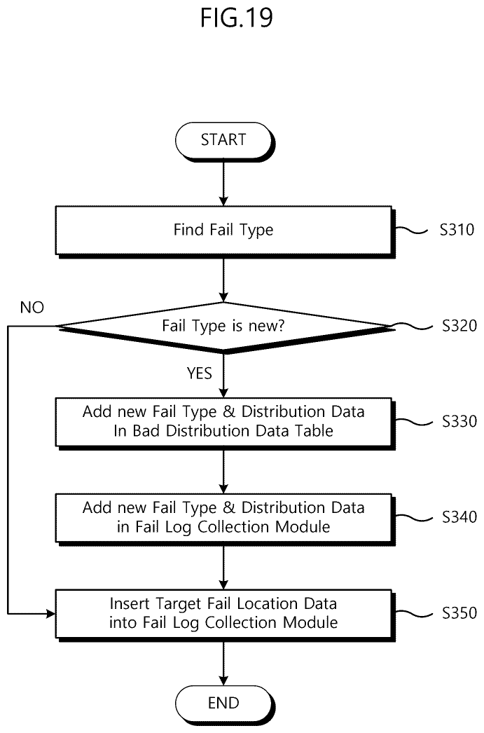

FIG. 19 is a flowchart illustrating an example embodiment of the operation method of the bad distribution update module shown in FIG. 16. Referring to FIGS. 17 and 19, the bad distribution update module 2400 may determine fail type (S310) and determine whether the fail type is new (S320). If fail type is new (YES), the bad distribution update module 2400 may add a new fail type and distribution data to the bad distribution data table 2100 (S330). The bad distribution update module 2400 may also add a new fail type and distribution data to the fail log collection module 2200 (S340).

The fail log managing unit 2004 may insert target fail location data into the fail log collection module 2200. The fail log managing unit 2004 may store the target fail location data in the fail log collection module 2200 by adding it as the new fail type. FD5 may be the newly stored fail location data in the fail log collection module 2200. In operation S320, if fail type is not new (NO), the fail log managing unit 2004 may insert the target fail location data into the fail log collection module 2200 (S350).

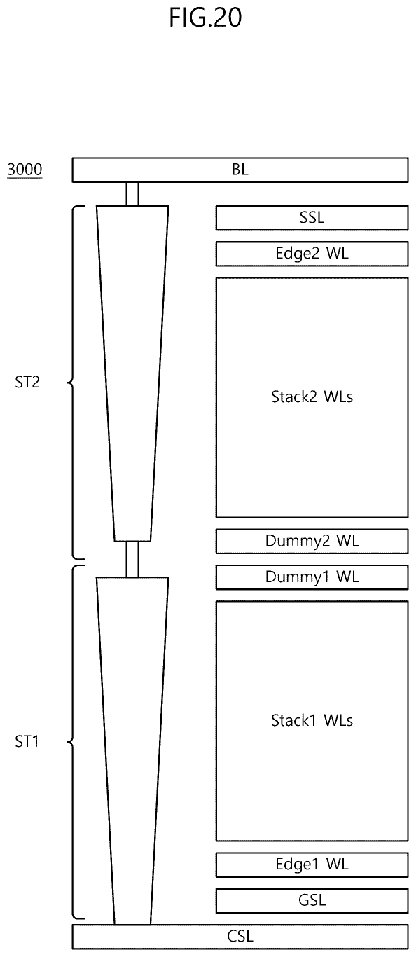

FIG. 20 is a diagram illustrating an example embodiment of a memory device having a multi-stack structure. The fail log managing unit 2000 illustrated in FIG. 1 may also be applied to a memory device 1100 having a multi-stack structure. Referring to FIG. 20, the memory device 3000 may have a first stack ST1 and a second stack ST2. The second stack ST2 may be located at the top of the first stack ST1.

A pillar of the memory device 3000 may be formed by bonding the first and second stacks ST1 and ST2. A plurality of dummy word lines (e.g., Dummy1 WL and Dummy2 WL) may be included near the junction of the first and second stacks ST1 and ST2. First stack word lines Stack1 WLs and a first edge word line Edge1 WL may be positioned between the common source line CSL and the first dummy word line Dummy1 WL. Second stack word lines Stack2 WLs and a second edge word lines Edge2 may be positioned between the second dummy word line Dummy2 WL and the bit line BL.

The first stack ST1 may include a ground selection line GSL, the first edge word line Edge1 WL, and the first stack word lines Stack1 WLs. The second stack ST2 may include the second stack word lines Stack2 WLs and the second edge word lines Edge2 WL. Each memory cell of the memory cells connected to the first and second edge word lines Edge1 WL and Edge2 WL may be configured to store a number of data bits different from a number of data bits that each memory cell of the memory cells connected to the first and second stack word lines Stack1 WLs and Stack2 WLs may be configured to store. For example, memory cells connected to the first and second edge word lines Edge1 WL and Edge2 WL may be single-level cell SLC (i.e., storing one bit data in a memory cell) or multi-level cell MLC (i.e., storing two bit data in a memory cell), and memory cells connected to the other word lines may be triple-level cell TLC (i.e., storing three bit data in a memory cell) or quadruple-level cell QLC (i.e., storing four bit data in a memory cell).

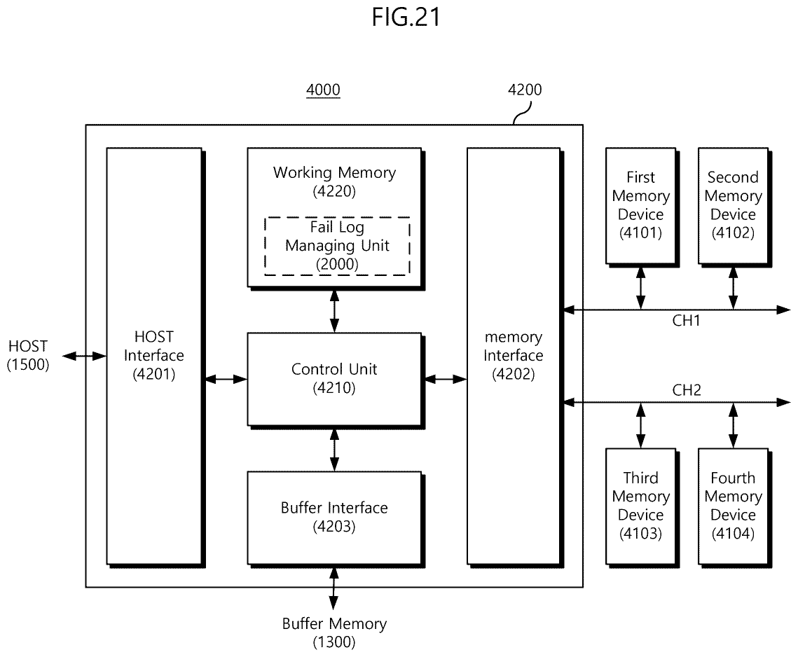

FIG. 21 is a block diagram illustrating a solid state drive (SSD) to which a storage device according to an embodiment of the present disclosure is applied. Referring to FIG. 21, an SSD 4000 may include a plurality of memory devices 4101 to 4104 and an SSD controller 4200.

The first and second memory devices 4101 and 4102 may be connected with the SSD controller 4200 through a first channel CH1. The third and fourth memory devices 4103 and 4104 may be connected with the SSD controller 4200 through a second channel CH2. The number of channels connected with the SSD controller 4200 may be two or more. The number of memory devices connected with one channel may be two or more.

The SSD controller 4200 may include a host interface 4201, a memory interface 4202, a buffer interface 4203, a control unit 4210, and a working memory 4220. The SSD controller 4200 may be connected with a host 1500 through the host interface 4201. Upon receiving a request from the host 1500, the SSD controller 4200 may write data in the corresponding memory device or may read data from the corresponding memory device.

The SSD controller 4200 may be connected with the plurality of memory devices 4101 to 4104 through the memory interface 4202 and may be connected with a buffer memory 1300 through the buffer interface 4203. The memory interface 4202 may provide data, which are temporarily stored in the buffer memory 1300, to the plurality of memory devices through the channels CH1 and CH2. The memory interface 4202 may transfer the data read from the plurality memory devices 4101 to 4104 to the buffer memory 1300.

The control unit 4210 may analyze and process the signal received from the host 1500. The control unit 4210 may control the host 1500 or the plurality memory devices 4101 to 4104 through the host interface 4201 or the memory interface 4202. The control unit 4210 may control operations of the plurality memory devices 4101 to 4104 by using firmware for driving the SSD 4000.

The SSD controller 4200 may manage data to be stored in the plurality of memory devices 4101 to 4104. In a sudden power-off event, the SSD controller 4200 may back up the data stored in the working memory 4220 or the buffer memory 1300 to the plurality of memory devices 4101 to 4104.

According to the present disclosure, a test time for performing a margin read test operation at high speed may be reduced.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A storage device comprising:
a memory device configured to store a plurality of data; and
a memory controller configured to classify data fails of the memory device by fail type, and to store the fail type and bad distribution data associated with data fails,
wherein the memory controller is configured to calculate similarity between first bad distribution data of a first data fail that has occurred in the memory device and the stored bad distribution data, and determine the fail type of the first data fail based on the similarity.

2. The storage device of claim 1, wherein the memory controller includes a fail log managing unit configured to store fail log data in a working memory, and wherein the fail log managing unit includes a bad distribution data table configured to store the bad distribution data by fail type and a fail log collection module configured to store the bad distribution data and fail location data corresponding to the fail type, in which the fail location data identifies location of a data fail in the memory device.

3. The storage device of claim 2, wherein fail location data for two or more fail locations categorized as the same fail type are stored in a row of the fail log collection module along with the bad distribution data corresponding to the same fail type.

4. The storage device of claim 2, wherein the fail log managing unit is configured to calculate the similarity between the first bad distribution data and the stored bad distribution data, and determine type ranking of the first bad distribution data for each fail type stored in the fail log collection module according to the similarity, in which the type ranking indicates a degree of similarity for each fail type.

5. The storage device of claim 4, wherein the fail log managing unit is configured to determine the fail type, collect target fail location data which identifies location of the first data fail of the memory device, and insert the target fail location data into the fail log collection module.

6. The storage device of claim 5, wherein the fail log managing unit further includes a bad block managing module configured to determine whether the fail type of a data fail that has occurred in a memory block of the memory device is recoverable.

7. The storage device of claim 6, wherein the bad block managing module is configured to reuse the memory block upon determining that the fail type is recoverable or process the memory block as a bad block upon determining that the fail type is not recoverable.

8. The storage device of claim 5, wherein the fail log managing unit further includes a bad distribution update module configured to update the bad distribution data table and the fail log collection module when the fail type of the first data fail is not categorized as one of fail types stored in the fail log managing unit.

9. The storage device of claim 2, wherein the fail log managing unit is configured to load fail log data stored in the memory device into the working memory when the storage device is powered up.

10. The storage device of claim 1, wherein the memory device is a flash memory.

11. A memory controller for managing data fail of a memory device, comprising:
a bad distribution data table configured to store bad distribution data categorized by fail type of a data fail of the memory device; and
a fail log collection module configured to calculate similarity between first bad distribution data of a first data fail that has occurred in the memory device and the bad distribution data stored in the bad distribution data table, and store the bad distribution data and fail location data categorized by the fail type according to the similarity.

12. The memory controller of claim 11, wherein fail location for two or more data fails categorized as the same fail type are stored in a row of the fail log collection module along with the bad distribution data corresponding to the same fail type.

13. The memory controller of claim 12, wherein the fail log collection module is configured to determine type ranking of the first bad distribution data for each fail type according to the similarity between the first bad distribution data and the stored bad distribution data.

14. The memory controller of claim 13, further comprising:
a bad block managing module configured to determine whether the fail type of the data fail in a memory block of the memory device is recoverable, and
wherein the bad block managing module is configured to reuse the memory block or process the memory block as a bad block depending on whether the fail type is recoverable.

15. The memory controller of claim 14, further comprising:
a bad distribution update module configured to update the bad distribution data table and the fail log collection module when the fail type of the first data fail is not categorized as one of fail types stored in the fail log collection module according to the similarity.

16. The memory controller of claim 11, wherein the memory controller is configured to load fail log data stored in the memory device into the bad distribution data table and the fail log collection module during power-up sequence.

17. The memory controller of claim 11, wherein the memory device is a flash memory.

18. An operating method of a memory controller for managing data fail of a memory device, the method comprising:
calculating similarity between first bad distribution data of a first data fail of the memory device and bad distribution data stored in a bad distribution data table; and
storing the bad distribution data and fail location data categorized by fail type in a fail log collection module according to the similarity.

19. The method of claim 18, further comprising:
determining whether the fail type of the data fail in a memory block of the memory device is recoverable, and
reusing the memory block or processing the memory block as a bad block depending on whether the fail type is recoverable.

20. The method of claim 19, wherein the bad distribution data includes information with respect to the threshold distributions of memory cells in a page or a memory block which includes the first data fail and the fail location data indicates location of the first data fail that currently has occurred in the page or the memory block.
